(19) United States
(12) Patent Application Publication
(10) Pub. No.: US 2026/0227084 A1
(43) Pub. Date: Aug. 6, 2026

(54) DIRECTIONAL SENSING APPARATUS FOR REDUCING ANOMALIES

(71) Applicant: Budderfly, Inc., Shelton, CT (US)

(72) Inventors: Christopher J. DeBenedictis, Branford, CT (US); Jaan Leemet, Aventura, FL (US)

(21) Appl. No.: 19/450,712

(22) Filed: Jan. 15, 2026

Related U.S. Application Data
(60) Provisional application No. 63/751,981, filed on Jan. 31, 2025.

(51) Int. Cl. F24F 11/63; G01K 3/14; G01K 13/024

(52) U.S. Cl. CPC F24F 11/63; G01K 3/14; G01K 13/024

(57) ABSTRACT

A system of distributed temperature sensors that is able to detect anomalous air flows and temperatures in a facility coupled with a system of directional control devices such as variable speed ventilators and exhaust vents that react to eliminate or mitigate drafts and heat sources and other temperature anomalies.

### FIELD OF THE INVENTION

The present disclosure relates to systems and methods for optimizing HVAC efficiency though the elimination of, or counteracting or mitigation of, hot spots or cold spots in a conditioned environment. In some examples, this may be accomplished through the application of detection mechanisms and targeted air movement, ventilation, and exhaust as some examples.

### BACKGROUND OF THE INVENTION

Certain heat sources can warm up a room and cause the HVAC to work harder in order to maintain a preset temperature. This includes things like a working oven or cooktop, condenser coils on a compressor, food warming trays, sun-facing windows, or even an open door, open window, or a leak in sealing.

While some heat sources are fixed and radiate heat from their location, some, like an open door or window in summer can lead to an influx of hot humid air which could be carried in by a draft.

In both cases, the warm air would mix with the cooler internal air and require the HVAC to cool the space to maintain a given preset temperature. This is typically detected by a thermostat setting which, once achieving a target temperature, activates the HVAC system which proceeds to cool the entire space again to achieve the desired setpoint. Activation of the HVAC system causes more air to be pulled into the return air ducts, which exacerbates the spreading of the warm air.

Similarly, in winter months, cold air from the outside can also mix with the heated conditioned air on a site’s premises and in a similar fashion the thermostat kicks in with heating to overcome the now lowered temperature of the space bringing it to the desired setpoint.

In addition to raising energy costs, these phenomena are also felt by the occupants as drafts and may cause manual interventions, whereby the occupants may react by further adjusting the thermostat settings to overcompensate for the unexpected drafts or there may be spots within the building that are colder than others while others are warmer, resulting in inconsistent comfort.

Further, the hot or cold draft can also make its way into a neighboring space (e.g. from the kitchen into the dining room, or from the entrance way into the dining room) making more than one HVAC system work harder in multiple areas to overcome the air which has been allowed to mix with the space, in other cases this hot or temperature air may be beneficial to the space by distributing that heated or cooled air to locations where such air would reduce the need to use the HVAC system. Further, when the neighboring space activates its HVAC unit, the return air duct intake can accelerate the movement of air into that neighboring space as well.

While some facilities have employed systems of air-curtains for front doors and windows, blowing a steady stream of air at a given area, these systems do not have the capability to react dynamically and directionally to temperature anomalies.

U.S. Pat. No. 11,659,693 to LeFebvre describes a data center heat removal system may include an adjustable thermal feed cold air intake system, a distribution system for cold and warm air including one or more hot aisles and one or more cold aisles, and a convection system to draw cool air through data center equipment using naturally-occurring convection processes to expel hot air. That is, some embodiments utilize passive pressure differences to expel hot air and bring in cool air, either alone or in combination with active use of fans or other air circulation devices. In addition, some embodiments may use heat exchangers. LeFebvre however does not contemplate specific hot or cool spot detection, nor does Lefebvre describe energy savings techniques to counteract hotspots directionally.

U.S. Pat. No. 11,280,513 to Lind provides an arrangement and method for determining adjustment parameters for at least two components utilized in an HVAC system. The arrangement comprises at least one processor and is configured to receive information regarding a duct configuration comprising at least one duct. The processor is additionally configured to receive target values for a first flow parameter at first and second duct locations corresponding to locations of the first and second components. At least one measured value for a second flow parameter at a measuring location is received and determined values for the second flow parameter at the first and second duct locations are resolved. First and second flow factors are determined, and first and second adjustment parameters may then be determined for the first and second components. Lind however does not consider selectively activating devices to distribute or remove air and provides for static adjustment of the HVAC system, a process typically referred to as balancing. This does not provide for directional fans or constant monitoring or adjustments of said system and is rather focused on balancing the air delivery to different rooms within a HVAC system, not adjusting for hot spots within the room itself, which hots spots may be created by the HVAC system itself.

In PCT Publication WO2024044590 to LeFebvre, describes a fire suppression method for an open-loop heat removal system in which a fire can be suppressed as hot air is expelled from a building, such as a data center or a home, without recycling, recirculating, or re-cooling the hot air. LeFebvre is thus detecting hot spots created by fires and is focused on fire suppression by closing louvers to cut of air supply and is not looking to move that heat within a room or building.

It would therefore be beneficial to provide a system to reduce or eliminate temperature imbalances in rooms.

### SUMMARY OF THE INVENTION

The present disclosure relates to detecting where the anomalous heat or cold source is coming from to then deploy a system of ventilation and/or exhaust to counteract the anomalous source in a directional manner. Such a system can potentially react and adjust before even the HVAC in the space is triggered by the existing thermostat. For example, in a kitchen environment with an exhaust hood whereby hot air from cooking rises and is pulled out of the kitchen through the kitchen hood, this hot air should be pulled out when cooling is in effect. Namely, this elimination of hot air prevents it from permeating adjacent spaces and triggering additional work for the HVAC.

It is thus contemplated that a system of directional venting and variable speed and/or directional fans can provide conditioned air and direct it towards a given source of heat or cold or move the anomalous air out of the space or a combination. In many cases, the usual sources can be determined such as doors and windows or the placement of existing refrigeration or cooking appliances. Further, exhaust venting to pull out the air affected by the anomalous sources is proposed so as to minimize the mixing of air within a given space.

It is therefore an object of the invention to provide for more consistent comfort in conditioned spaces.

It is yet another object of the invention to reduce anomalous conditions in spaces, for example to reduce or eliminate hot and/or cold spots.

It is yet another object of the invention to reduce energy use and provide more efficient conditioning of spaces.

These and other objects are achieved by providing a system and method that can sense and eliminate or counter anomalous temperature areas in a space though the use of sensors for location based detection and directional ventilation and conditioning for counteracting and adjustment. This directional ventilation/supply may be, for example through fans or venting which can move or rotate to pull or push air to or from the location detected or may utilize fixed vents/fans in which multiple vents/fans in combination create a directional push or pull of air to or from the location detected.

In some aspects the multiple sensors are strategically placed within a space, and in particular positioned around areas that are likely to generate temperature differentials. Sensors may be used to detect air movement to determine the direction and/or speed from which a temperature anomaly is arriving. Furthermore, the system may use multiple strategically placed exhaust vents and ventilation systems that are able to direct air both in and out of a space creating an air flow. These ventilation and exhaust systems may operate with variable speed fans so as to regulate the speed at which air is entering and exiting a space. Further, directional louvers or other air direction systems are employed to pin-point the intruding air and/or to efficiently counter the incoming air flow towards the exhaust vent or vents.

In one configuration, sensors are provided that detect anomalous temperature readings and determine the intrusion point, direction and speed of an anomalous temperature draft. Ventilation is triggered to direct the intruding air towards one or more exhaust vents, and the variable speed fans on the exhaust and ventilation systems are triggered and the flow of air directed so as to eliminate the intruding air before it can further mix with the overall air in the space.

In some cases, the intruding air may be pushed back out or prevented from entering in the case of an open door or window. In other cases, where heat may be radiating, for example from a cook top or hot compressor coil, the air is directed though the use of ventilation towards exhaust vents or that warm air may be directed back towards the source if appropriate, for example a food warmer/warming area.

The various sources of heat and subsequent air movement actions can be configured or programmed into the system when it is installed and configured and seasonal configurations and detections could be implemented, for example seasonal devices such as soup warmers or sandwich warmers or seasonal chillers may be used temporarily and the system can then redirect any hot (or cold) air back towards these instead of blowing ambient air across them.

In certain aspects a machine learning system is employed to learn and improve on the rate at which the flow is regulated, triggered, and managed. The Machine Learning models are continually retrained over time to improve efficiency. The system also learns from the energy use monitoring to most efficiently measure the impact of redirecting the flow vs allowing it to mix and to adjust the rate of ventilation and exhaust.

In certain aspects the system provides directional comfort anomaly detection and mitigation with a controller having software executing thereon. The controller is configured to receive sensor data from one or more of a plurality of sensors and to transmit control instructions to one or more of a plurality of control devices. The plurality of sensors are positioned in different sensor locations within a space to be controlled and are configured to measure comfort characteristics in the vicinity of each sensor’s respective location, said software associating each of the plurality of sensors with its respective one of the different sensor locations. Each of the plurality of control devices positioned in different control device locations within the space to be controlled, each control device configured to move, add and/or remove fluid within the space to modify comfort characteristics within the space. The controller identifies one or more deviating sensors of the plurality of sensors which deviating sensor reads a comfort characteristic which deviates from a threshold for said space based on said sensor data and based on if the comfort characteristic as measured by said sensor data is above or below the threshold, said controller identifies one or more of the control devices and is configured to transmit control instructions to the one or more of the control devices to move, add and/or remove fluid within the space which fluid which is to be moved, added and/or removed is conditioned in a manner to bring the sensor reading in the vicinity of the sensor location of the one or more deviating sensors within the threshold. The identified one or more of the control devices are identified by the controller based on a position of the respective sensor location within the space compared to a device position of the one or more identified control devices in order to focus the movement, addition and/or removal of fluid within the space by the control device to the position of the respective sensor location.

In certain aspects the fluid is air. In other the one or more identified control devices include two control devices which are configured to move, add and/or remove fluid each along a different path which is computed by the control device to create a fluid current through an area corresponding to the sensor location, which sensor location corresponds to the one or more deviating sensors. In still other aspects, the one or more identified control devices are identified based on an identified speed with which fluid is added, removed and/or moved by said devices based on the control instructions. In yet other aspects, the control instructions include a speed setting for one or more of the identified control devices to cause the identified control devices to operate at the respective identified speed. In certain aspects the speed setting is different for each of the identified control devices. In still other aspects the speed setting causes one or more vents to be restricted. In other aspects each control device is associated at the software with a direction at which the control device is configured to add, move or remove fluid within the space. In still other aspects the direction is a range of directions and is adjustable for one or more of a plurality of control devices.

In other aspects a method for providing directional comfort anomaly detection and mitigation is provided including one or more steps of: receiving sensor data from a plurality of sensors at software executing on a controller, the sensors positioned in different sensor locations throughout a space and are configured to measure comfort characteristics in the vicinity of each sensor’s respective location; by the controller, comparing said sensor data to one or more thresholds to identify a comfort anomaly in an area of the space associated with one or more deviating sensors of the plurality of sensors which deviating sensors deviate from a threshold for said space and selecting and controlling one or more of a plurality of control devices positioned in different control device locations within the space to be controlled to move, add and/or remove fluid within the space based on if the comfort characteristic as measured by said sensor data is above or below the threshold and the selecting and controlling computed by the controller to move fluid relative to an area defined by sensor locations of the one or more deviating sensors.

In certain aspects the fluid is air and in certain aspect the one or more identified control devices include two control devices which are configured to move, add and/or remove fluid each along a different path which is computed by the control device to create a fluid current through an area corresponding to the sensor location of the one or more deviating sensors. In other aspects the one or more identified control devices are identified based on an identified speed with which fluid is added, removed and/or moved by said devices based on the control instructions. In still other aspects the control instructions include a speed setting for one or more of the identified control devices to cause the identified control devices to operate at the respective identified speed. In other aspects the speed setting is different for each of the identified control devices. In still other aspects the speed setting causes one or more vents to be restricted. In still other aspects the speed setting causes a motor associated with a fan of the identified control device to operate based on the speed setting. In yet other aspects the one or more identified control devices include at least one control device which introduces conditioned fluid into the space and at least one control device which removes fluid from the space. In yet other aspects the one or more identified control devices include at least one control device which moves fluid within the space to another location in the space. In still other aspects at least one of the one or more identified control devices is located at or adjacent to a perimeter of the space located along vertical walls of the space. In yet further aspects at least one of the one or more identified control devices is positioned within the space away from a perimeter of the space located along vertical walls of the space. In still other aspects each control device is associated at the software with a direction at which the control device is configured to add, move or remove fluid within the space. Further, the direction may be a range of directions and is adjustable for one or more of a plurality of control devices.

While the focus in the descriptions and the examples used herein relate to restaurant environments, this disclosure is not limiting and can be applied to other environments. Other aspects, advantages and features of the invention will become apparent from consideration of the following description taken in conjunction with the accompanying drawings.

### BRIEF DESCRIPTION OF THE DRAWINGS

FIG. 1 is an overview of the major components of the system.

FIG. 2A is a perspective view the system at a given site where components of a small quick serve restaurant are shown.

FIG. 2B is a perspective view of the system in an alternative configuration.

FIG. 3A is a view of a sample facility with sensors deployed throughout the space.

FIG. 3B is a view of the same sample facility with the additional details of ventilation and exhaust systems at strategic locations

FIG. 3c is a view of the same sample facility with sensors and ventilation depicting the detection and countering of a hotspot

FIG. 4 depicts the various components in block form of the system

FIG. 5 is a functional flow diagram illustrating how the system reacts to temperature and adjust its operation

### DETAILED DESCRIPTION OF THE INVENTION

Reference will now be made in detail to specific embodiments illustrated in the accompanying drawings. In the following detailed description, numerous specific details are set forth to provide a thorough understanding. However, it will be apparent to one of ordinary skill in the art that embodiments may be practiced without these specific details. In other instances, known methods, procedures and/or components have not been described in detail so as not to unnecessarily obscure aspects of the embodiments.

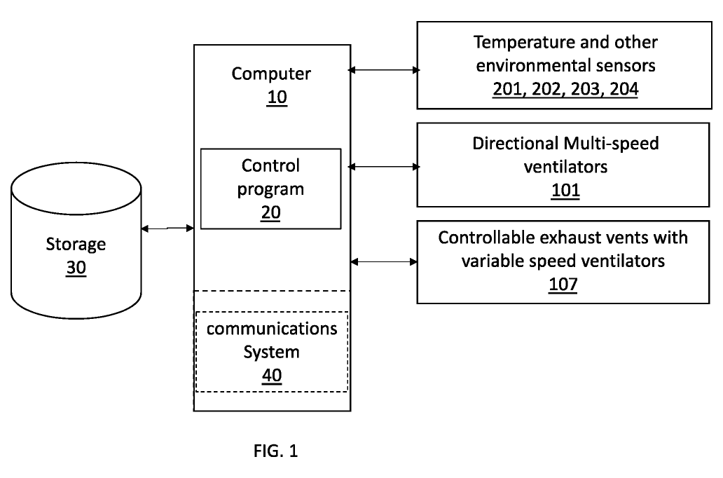

FIG. 1 shows an overview of the major components of the system. A computer 10 with a control program 20 and a communications system 40 is connected to storage 30 and communicates with temperature and environmental sensors 201, 202, 203, 204 to gather data and controls various control devices which can add, remove and/or move fluid such as air into, out of or within the space being controlled. Examples of such control devices include directional multi-speed ventilators 101 (which may also include a heating/cooling supply and controllable exhaust vents with variable speed ventilators 107.

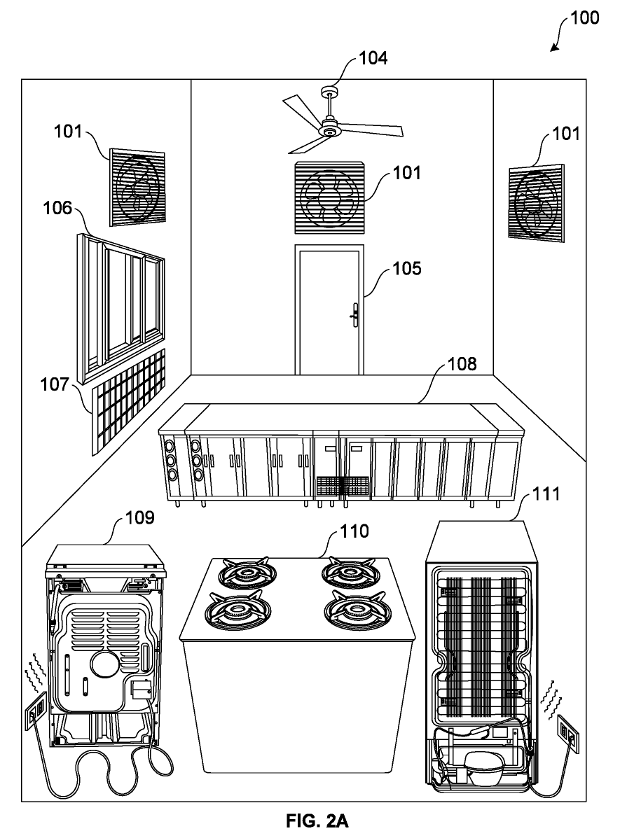

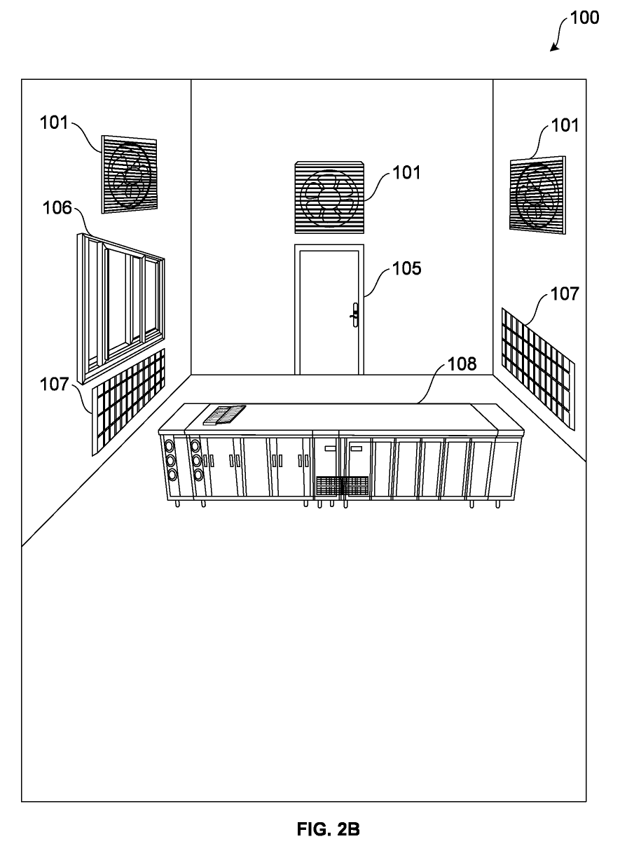

FIG. 2A shows the system at a given site where components of a small quick serve restaurant are shown 100. A refrigerator 111 and a stove 110 with a freezer 109 are shown behind a serving counter 108. The doorway 105 has a ventilator on top of it 101 and a window 106 also has a ventilator 101 and an exhaust vent 107. There is also a ventilator 101 and exhaust vent 107 on the opposite wall of the facility. A ceiling fan 104 is also provided. This layout is only meant to be exemplary, and the location of ventilation and exhaust components is strategically made to be where predicted hot and cold spots may originate. For example, around doors and windows or around kitchen cooking appliances or refrigeration coils. These control devices 101/104/107 are controllable by the system computer/controller 10, the control instructions delivered to control these devices may be to vary the speed of the fan, to heat or cool, to turn on/off, to adjust venting/vent position as but some examples. Such devices are but a few examples of possible control devices that the computer 10 can control. The HVAC vents themselves may also be examples of control devices which are controllable in that the vents may be opened/closed or adjusted in position between open and closed to adjust the delivery of heated/cooled air. Furthermore, the overall HVAC system may also be controlled to turn on/off and may be considered a control device as well. FIG. 2B shows an example similar to FIG. 2A, but where several devices shown in FIG. 2A are absent from the space in question. These devices not shown in FIG. 2B but present in FIG. 2A may be, for example in another room of the facility or one or more may not be in the facility.

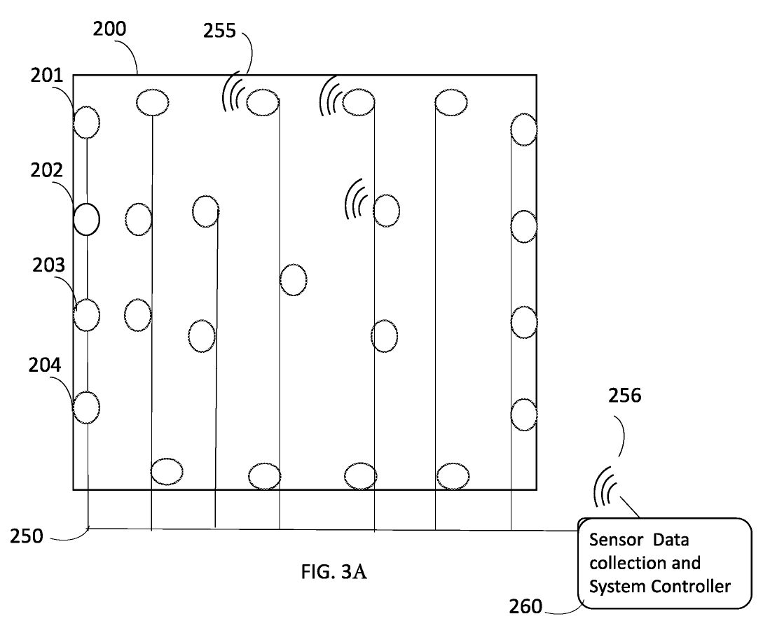

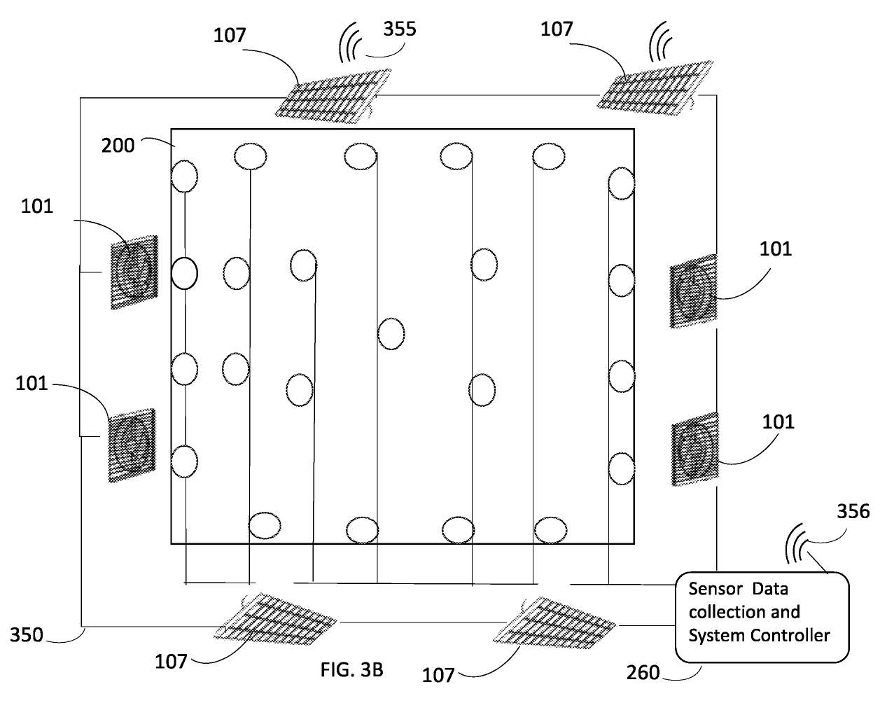

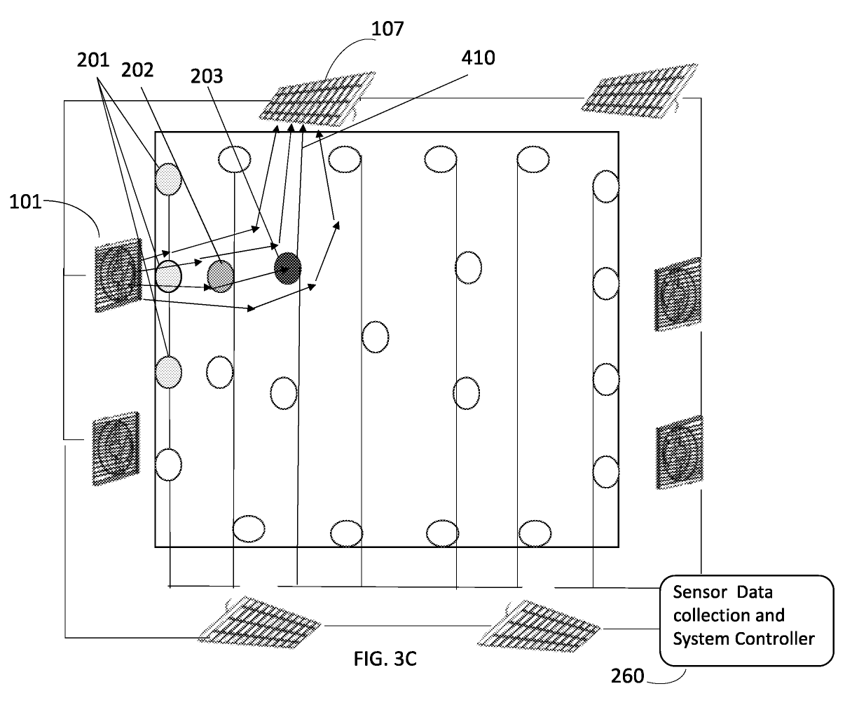

FIG. 3a shows a sample facility with sensors deployed throughout the space 200. Environmental sensors 201, 202, 203, 204 and more are placed in strategic locations within the facility to detect hot spots and cool spots. These sensors (201-204 and more) are connected through either wireless communication 255,256 or through wired communication 250 to a sensor data collection system 260 in the facility which connects to the computer 10. This system 260 could also reside in the cloud or be part of a more comprehensive energy management system or facilities controller. Each sensor of a given type is associated with its particular location which is different than other sensors of the same type. The sensor in question may be a pack of multiple sensors including temperature, humidity, light, air quality and a variety of other types of sensors. Using the example of temperature sensors and the environmental sensors shown measuring temperature, the controller would associate the coordinate location of each sensor with a grid, which may be defined (for example) by the walls or some other reference point. The vertical line shown in FIG. 3A along which numbers 201-204 are shown can be considered the Y axis with the intersecting wall being the X axis. The sensor positions can also designate three dimensional position along the Z axis (out of the page) to indicate the height of the sensor.

FIG. 3b shows the same sample facility with the additional details of the control devices such as ventilation and exhaust systems at strategic locations. Like the sensors, the coordinates of the control devices would be known to the computer 10. As shown, ventilators 101 are strategically placed around the facility 200. Exhaust systems 107 are also strategically placed within the facility. These are connected through either wireless communication 355,356 or through wired communication 350 to a sensor data collection system and controller 260 in the facility. This system 260 could also reside in the cloud or be part of a more comprehensive energy management system or facilities controller. The computer/controller and its associated software is configured to control these control devices 101, 104, 107 to, for example, turn them on/off, increase/decrease speed, modify direction and change louver/vent openings sizes.

FIG. 3c shows the same sample facility with sensors and ventilation depicting the detection and countering of a hotspot with the working system. Sensor 203 is depicted in a darker color so as to indicate that it has detected a hotter than normal anomalous temperature. The darker color depicts that it is much hotter than the rest of the sensors and what is expected by the sensors. Sensor 202 is also depicted as a darker color but not quite as dark as sensor 203. The intention is to depict that this sensor is also hotter than normal but not quite as hot as sensor 203 at the given time. Further 3 sensors 201 are just slightly off color suggesting just a small change in temperature but enough to be over a given threshold to trigger the system into action. The variance in temperature depicted by color on this figure gives the system the knowledge of the source of the hot spot and the direction of the heat as it is radiating or dissipating through the facility.

Given enough time, and if no action is taken the head will mix with the rest of the air in the facility and will trigger the normal HVAC system into action to cool the whole space to account for the anomalous heat source.

With the sensors showing the system the heat spot, and the direction that the heat is moving, the system knows which ventilator 101 is the closest ventilator to the source and can provide cooling in the opposite direction that the heat is moving. Further the system knows which exhaust ventilator 107 is also nearest to the heat source and can be strategically triggered to remove the countering air current, and the heated air caused by the heat source.

An airflow 410 is depicted coming from ventilator 101 and being pulled out by exhaust ventilator 107 causing a current of cold air over a pathway along or in the vicinity of the sensors 201, 202, and 203 creating a cooling effect and countering the source of heat.

If the heat source is a transient event, the sensors 203, 202, and 201 will eventually cool to a normal setting, shutting down the air flow 410 between one or more of the ventilators 101 and one or more of the exhaust ventilators 107.

Depending on the configuration, and the variance in temperature detected it is conceivable that the system may trigger multiple ventilator and or multiple exhaust ventilators to counter the source of heat. It is also conceivable that the use of heat sinks can be used in some configurations to gather and collect heat in a known location that can be targeted by the ventilation system. A similar example would apply to a cold spot, for example in the winter where heated air would be introduced and the ventilator would be activated to move out the colder air, the result is a similar current of air in a target and directional pathway to counteract/mitigate certain locations that are sensed to be showing a temperature anomaly.

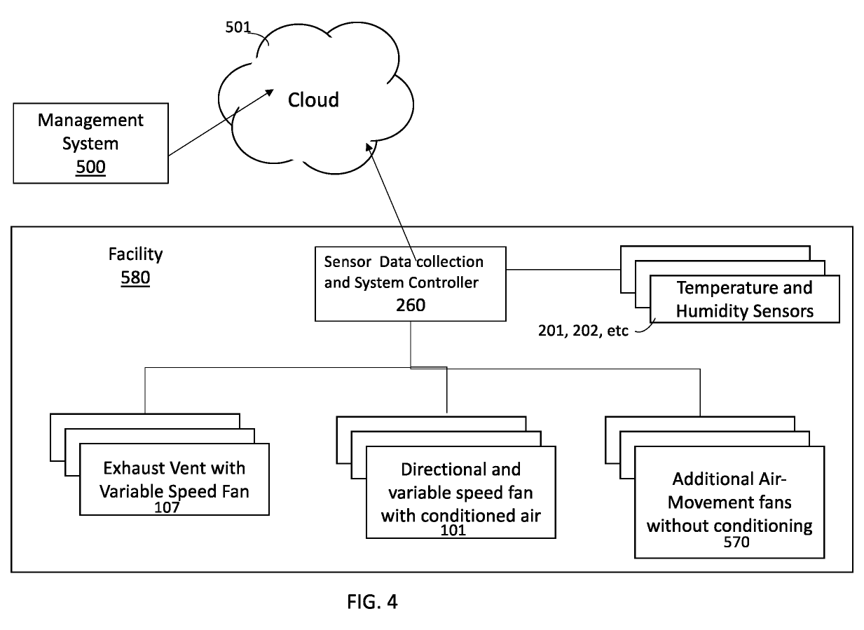

FIG. 4 shows various components in block form of the system. The central management system 500 is connected through the cloud 501 to the sensor data collection and control system 260 which was also depicted in the other diagrams. The central system 500 can deploy control logic and system upgrades to the sensor data collection and control system 260 which is typically on the facility 580. The sensor data collection system is connected to temperature and humidity sensors 201, 202, etc and sends control signals to exhaust vents 107, directional and variable speed fans 101 and additional air movement fans without conditioning 570 (which may include the ceiling fan 104 and/or other fans).

While in some embodiments, the ventilation systems provide conditioned air 101, in others they may simply provide air movement 570. It should also be noted that some ventilation system also provides louvers to adjust the angle and flow of the exiting air allowing the system to better target the location of the hot spots. The configuration and calibration of the system is done at install time, and the system maps out the x, y and z coordinates of the installation of each control device and its features as well as each sensor to allow for such calibration. The mapped features may be the angle range through which louvers can be set to direct air, heating and cooling functions, variability of speed functions and other features indicative of the particular control device’s range of ability to move and/or condition air and in what directions/ranges of directions. Further, feedback to the system through the detection of changes in the temperature from triggering the air flow also allow it to better calibrate or adjust the airflow to best counter the hot spots detected.

Again, while the examples above use hot spots and cool air, the opposite can easily be performed when cold air in the winter may cause cold spots, and the conditioned air is heated and blows hot air over such cold spots pushing the cold air out the exhaust ventilators.

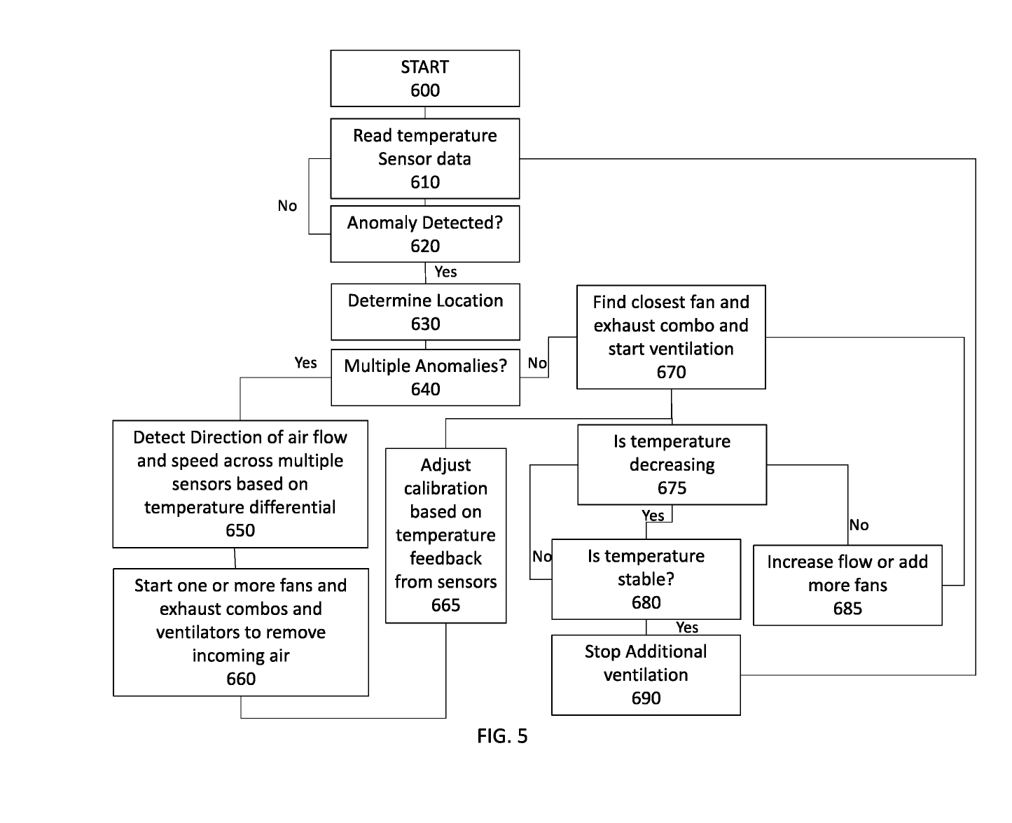

FIG. 5 is a functional flow diagram illustrating how the system reacts to temperature and adjust its operation accordingly. Upon start 600 temperature sensors (201, 202, etc) are read 610 and monitored looking for any anomalies. These anomalies are based on threshold temperatures which are set and dynamically adjusted with the aid of machine learning. The threshold values that can justify the added energy cost of triggering the system instead of allowing the normal HVAC to react and counter the system are part of the equation and learned through the run time of each system and the energy utilization determined through metering of the energy use and/or run time of the systems. These factors may also leverage real time energy cost data and potential effect on the business if anomalies occur during busy times when the space is occupied. Historical use and temperature prediction are all used by the machine learning system.

If an anomaly is detected 620 the location is detected 630 and the closest fan and exhaust combination 670 are selected and triggered. This selection of the control devices is exemplary, and it is possible that only one control device or more than two control devices may be used. The selection will depend on where the anomaly is and what control devices can be activated to create a pathway or current of air movement to eliminate or mitigate against the hot/cold spot. Depending on the variance in temperature of the anomaly the speed of the fans in a variable speed system are adjusted. Depending on the location, the louver positioning and directionality of the airflow are also adjusted to counter the hot (or cold) spot detected. The system then monitors the anomaly temperature 675 and adds more flow of fans 685 if not. If the temperature is stable 680 then the additional ventilation can be stopped 690 and the system goes back to monitoring the sensors.

If multiple anomalies are detected 640 then the directionality of air flow 650 is calculated based on the variance of temperature of the affected sensors and a counter flow is calculated and put into effect 660. The calibration is adjusted 665 based on the feedback from the sensors when the airflow is successfully reducing the temperature of the hot spots. This calibration may involve changing the direction of the air flow with louvers that are built into some ventilators. Machine learning is also used to enhance the calibration based on air flow and measurements.

In an example of an air-conditioned space with a set temperature of 70 deg F and when it is 90 deg F outside, it may initially take many hours to reduce the temperature to the desired set point. Once the room has cooled to 70, takes less energy is needed to maintain the room at this consistent temperature.

If a window is opened, and warm air is entering a space at a high rate and is allowed to mix with the air in the facility, the temperature in the room will increase and the HVAC will trigger to cool the overall space. The return air ducts of the HVAC system will draw in the air which, in turns, brings more air in through the opening thus accelerating the warming. This is also dependent on the location of the thermostat. It is possible that if the incoming hot temperature is far from the thermostat, the space will heat up disproportionately in the area near the window becoming uncomfortable for the occupants. Alternatively, if the warm air is close to the thermostat, the HVAC kicks in to compensate and overcools the main area. By triggering an airflow that pushes the warm air back towards the window or out an exhaust vent before it can mix with the surrounding air in the facility or directing conditioned air towards the anomalous air temperature’s location in a targeted manner, the larger HVAC system used for energy intensive cooling or conditioning of the overall space is not triggered or runs for a shorter period of time, thus maintaining the desired facility temperature without having to overcool the space or cause disproportionally cool or warm areas for its occupants.

Sensors positioned throughout the space, typically in strategic places in the space, can detect the location of the intrusion of different temperature air. This allows the ability for the system to pinpoint the location the different temperature air was coming from and react before mixing occurs, changing the overall temperature. In addition to sensors, the system provides the ability to direct that different temperature air into a ventilation exhaust vent to prevent the mixing from occurring. Such as system would retain the overall temperature of the room whereby the warm air entering would be quickly expelled before it had a chance to mix and cause the HVAC to work harder to reduce the overall room temperature.

As another example, a stove top station radiates hot air throughout the kitchen forcing the HVAC to work harder to condition the whole space. While typical systems may employ a stove top exhaust vent to exhaust the hot air, this type of system also removes much of the conditioned air in the space due to the pressure differential caused by removing the hot air. The proposed system would instead detect the hot area, target the hot area with directional vents which may pull inside or outside air, and assist in directing the hot air into the exhaust vent with minimal impact to the surrounding space. While some demand control kitchen ventilation systems have built in variable speed motors and heat sensors, these are simply used for exhausting the hot air and gases and do not work with other features in the rest of the space. However, in the present system, such devices could be connected to and controlled by the computer as other control devices to better balance the temperature needs of the space. Once the stove top is turned off and allowed to cool down, the system would detect a return to a normal temperature and would turn off the directional ventilation and exhaust. In the scenario of temperature sensing near a heat source such as a cooking station, different temperature thresholds for those sensors in the vicinity of that area may be used in comparison to, for example a seating area or bar area.

Assuming the source of hot air is mitigated, the return to normal of the space would be less work to the HVAC system whereas has the heating source remained in place for longer the surrounding room would have been warmed and the HVAC would have had to work harder throughout the cooking cycle and continue to work hard after to reestablish the baseline temperature.

In many cases, the hot/cold spots for a given space are predictable and sensors and ventilation can be placed accordingly in the space design. These spots are generally in the area of windows, doors, cooking appliances, food warming appliances, and refrigeration coils. Other areas in a restaurant environment can include heating lamps, and food warmers. Even busy areas with high occupancy rates can change the temperature of a space and can be considered hot/cold spots.

Machine learning algorithms are further employed to optimize the detection, the flow, and the timing of the ventilation and exhaust to improve upon energy savings and air management. The Machine Learning models are continually retrained over time to further learn and optimize the air flow algorithms. Sensors are placed strategically around the room, and in particular in areas, such as windows and doors, where such hot/cold spot creating events were more likely to occur. Further, secondary sensors are placed in strategic areas that are able to detect the directionality of the anomalous air flow.

Fans to direct air in such a way that this air would flow towards an exhaust vent or even simply into the plenum where it would have minimal effect or impact on the comfort of any occupants, capturing and redirecting the anomalous air flow. Velocity of the countering air flow is regulated by variable speed fans on both the incoming air supply and the exhaust vent allowing such a system to overcome strong drafts and not over-react to smaller drafts. The flow rate can be measured by the time differential of the temperature sensors or through other air flow measurement sensors.

The end result would be that the incoming hot air would not be distributed into the larger space but would instead be directed towards the ventilation and exhaust system efficiently thus affecting only a small portion of the room.

It is also conceived that in some instances, such as in the winter months, the system would work to distribute any heat detected instead of removing it. In such cases, if a heat source was detected, rather than remove the heat from a vent, the system of air movement could either let the heat radiate throughout the space, saving energy on subsequent heating, or could also use its fans to cause air movement displacing the heat into the space more rapidly. This can also aid in reducing the energy used in winter months when the system is set to heat.

While a little more energy is required to exhaust and ventilate the specific area, the overall impact to energy use is improved and the elimination of hot/cold spots and draft areas are added benefits of the invention.

There are no limitations in terms of the particular embodiments described in this application, which are intended as illustrations of various aspects only. Many modifications and variations can be made without departing from its spirit and scope, as will be apparent to those skilled in the art. Functionally equivalent methods and apparatuses, in addition to those enumerated herein, will be apparent to those skilled in the art from the foregoing descriptions. Such modifications and variations are intended to fall within the scope of the appended claims. Only the terms of the appended claims are intended to be limiting, along with the full scope of equivalents to which such claims are entitled. It is also to be understood that the terminology used herein, e.g., “and”, “or”, “including”, “at least” as well as the use of plural or singular forms, etc., is for the purpose of describing examples of embodiments and is not intended to be limiting.

What is claimed is:

1. A system for providing directional comfort anomaly detection and mitigation comprising:
a controller having software executing thereon, said controller configured to receive sensor data from one or more of a plurality of sensors and to transmit control instructions to one or more of a plurality of control devices;
said plurality of sensors are positioned in different sensor locations within a space to be controlled and are configured to measure comfort characteristics in the vicinity of each sensor’s respective location, said software associating each of the plurality of sensors with its respective one of the different sensor locations;
each of said plurality of control devices positioned in different control device locations within the space to be controlled, each control device configured to move, add and/or remove fluid within the space to modify comfort characteristics within the space;
said controller identifying one or more deviating sensors of the plurality of sensors which deviating sensor reads a comfort characteristic which deviates from a threshold for said space based on said sensor data and based on if the comfort characteristic as measured by said sensor data is above or below the threshold, said controller identifies one or more of the control devices and is configured to transmit control instructions to the one or more of the control devices to move, add and/or remove fluid within the space which fluid which is to be moved, added and/or removed is conditioned in a manner to bring the sensor reading in the vicinity of the sensor location of the one or more deviating sensors within the threshold;
wherein the identified one or more of the control devices are identified by the controller based on a position of the respective sensor location within the space compared to a device position of the one or more identified control devices in order to focus the movement, addition and/or removal of fluid within the space by the control device to the position of the respective sensor location.

2. The system of claim 1, wherein the fluid is air.

3. The system of claim 1, wherein the one or more identified control devices include two control devices which are configured to move, add and/or remove fluid each along a different path which is computed by the control device to create a fluid current through an area corresponding to the sensor location, which sensor location corresponds to the one or more deviating sensors.

4. The system of claim 3, wherein the one or more identified control devices are identified based on an identified speed with which fluid is added, removed and/or moved by said devices based on the control instructions.

5. The system of claim 4, wherein the control instructions include a speed setting for one or more of the identified control devices to cause the identified control devices to operate at the respective identified speed.

6. The system of claim 5, wherein the speed setting is different for each of the identified control devices.

7. The system of claim 5, wherein the speed setting causes one or more vents to be restricted.

8. The system of claim 1, wherein each control device is associated at the software with a direction at which the control device is configured to add, move or remove fluid within the space.

9. The system of claim 8, wherein the direction is a range of directions and is adjustable for one or more of the plurality of control devices.

10. A method for providing directional comfort anomaly detection and mitigation comprising:
receiving sensor data from a plurality of sensors at software executing on a controller, the sensors positioned in different sensor locations throughout a space and are configured to measure comfort characteristics in the vicinity of each sensor’s respective location;
by the controller, comparing said sensor data to one or more thresholds to identify a comfort anomaly in an area of the space associated with one or more deviating sensors of the plurality of sensors which deviating sensors deviate from a threshold for said space and selecting and controlling one or more of a plurality of control devices positioned in different control device locations within the space to be controlled to move, add and/or remove fluid within the space based on if the comfort characteristic as measured by said sensor data is above or below the threshold and the selecting and controlling computed by the controller to move fluid relative to an area defined by sensor locations of the one or more deviating sensors.

11. The method of claim 10, wherein the fluid is air.

12. The method of claim 10, wherein the one or more identified control devices include two control devices which are configured to move, add and/or remove fluid each along a different path which is computed by the control device to create a fluid current through an area corresponding to the sensor location of the one or more deviating sensors.

13. The method of claim 12, wherein the one or more identified control devices are identified based on an identified speed with which fluid is added, removed and/or moved by said devices based on the control instructions.

14. The method of claim 13, wherein the control instructions include a speed setting for one or more of the identified control devices to cause the identified control devices to operate at the respective identified speed.

15. The method of claim 14, wherein the speed setting is different for each of the identified control devices.

16. The method of claim 14, wherein the speed setting causes one or more vents to be restricted.

17. The method of claim 14, wherein the speed setting causes a motor associated with a fan of the identified control device to operate based on the speed setting.

18. The method of claim 10, wherein the one or more identified control devices include at least one control device which introduces conditioned fluid into the space and at least one control device which removes fluid from the space.

19. The method of claim 10, wherein the one or more identified control devices include at least one control device which moves fluid within the space to another location in the space.

20. The method of claim 10, wherein at least one of the one or more identified control devices is located at or adjacent to a perimeter of the space located along vertical walls of the space.

21. The method of claim 10, wherein at least one of the one or more identified control devices is positioned within the space away from a perimeter of the space located along vertical walls of the space.

22. The system of claim 10, wherein each control device is associated at the software with a direction at which the control device is configured to add, move or remove fluid within the space.

23. The system of claim 22 wherein the direction is a range of directions and is adjustable for one or more of a plurality of control devices.
